(19) United States
(12) Patent Application Publication
(10) Pub. No.: US 2020/0076683 A1
(43) Pub. Date: Mar. 5, 2020

(54) Dynamic Cloud-Based Provisioning of Branch-Based Networking Devices

(71) Applicant: HEWLETT PACKARD ENTERPRISE DEVELOPMENT LP, Houston, TX (US)

(72) Inventors: Sanjay Hegde, Bangalore (IN); Gopakumar Nambisan, Bangalore (IN); Suchin Somashekar, Bangalore (IN); Krisnamoorthy Joshi, Bangalore (IN)

(21) Appl. No.: 16/118,677

(22) Filed: Aug. 31, 2018

(51) Int. Cl. H04L 12/24; H04L 29/08

(52) U.S. Cl. CPC H04L 41/0806; H04L 41/12; H04L 67/34; H04L 41/0246; H04L 41/046; H04L 41/0843

(57) ABSTRACT

A branch office controller (BoC) of a software-defined wide-area network (SDWAN) is configured to collect real-time network physical connection and connected device information and pass this information to the cloud platform server. This enables the cloud platform server to combine the information in a configuration template and other predetermined network device information with the real-time network physical connection and connected device information in order to generate provisioning information provided to the BoC to effectuate provisioning of network devices.

### CROSS-REFERENCE TO RELATED APPLICATIONS

Not Applicable

### BACKGROUND

Cloud-based provisioning of network devices is a popular methodology employed in computer networks, particularly in software-defined wide-area networks (SDWANs). SDWANs are often provided, for example, to provide an infrastructure between a central office and a branch location of an enterprise.

SDWANs represent a specific application of software-defined networking (SDN) technology applied to wide-area network (WAN) connectivity. SDWANs may include at least one Branch Office Controller (BoC) located at a branch office in network communication with at least one master controller (MC) located at a central office. A first cloud provisioning redirector server referred to as a provisioning server can function to establish communication between the branch office and the central office, such as between an MC and a BoC. A network platform computing resource, such as a cloud platform server, can provide a configuration template and device address details specified for the branch office to the MC, which in turn, pushes this configuration information to the branch office.

### BRIEF DESCRIPTION OF THE DRAWINGS

For a detailed description of various examples, reference will now be made to the accompanying drawings, in which:

FIG. 1 is a schematic of an example SDWAN infrastructure;

FIGS. 2A and 2B are a flow diagram depicting an operational methodology of an SDWAN, according to one or more examples of the disclosure;

FIG. 3 is a flow diagram depicting an operational methodology of an SDWAN, according to one or more examples of the disclosure;

FIG. 4 is a flow diagram depicting another operational methodology of an SDWAN, according to one or more examples of the disclosure; and

FIG. 5 is a block diagram representing a computing device implementing an SDWAN provisioning methodology according to one or more disclosed examples.

### DETAILED DESCRIPTION

In the following description, for purposes of explanation, numerous specific details are set forth in order to provide a thorough understanding of the examples disclosed herein. It will be apparent, however, to one skilled in the art that the disclosed example implementations may be practiced without these specific details. In other instances, structure and devices are shown in block diagram form in order to avoid obscuring the disclosed examples. Moreover, the language used in this disclosure has been principally selected for readability and instructional purposes and may not have been selected to delineate or circumscribe the inventive subject matter, resorting to the claims being necessary to determine such inventive subject matter. Reference in the specification to “one example” or to “an example” means that a particular feature, structure, or characteristic described in connection with the examples is included in at least one implementation.

The terms “computing system” and “computing resources” are generally taken to refer to at least one electronic computing device that includes, but is not limited to, a single computer, virtual machine, virtual container, host, server, laptop, and/or mobile device or to a plurality of electronic computing devices working together to perform the function described as being performed on or by the computing system. The term also may be used to refer to a number of such electronic computing devices in electronic communication with one another.

As used herein, the term “medium” refers to one or more non-transitory physical media that together store the contents described as being stored thereon. Examples may include non-volatile secondary storage, read-only memory (ROM), and/or random-access memory (RAM). Such media may be optical or magnetic.

As used herein, the terms “application” and “function” refer to one or more computing modules, programs, processes, workloads, threads and/or a set of computing instructions executed by a computing system. Example implementations of applications and functions include software modules, software objects, software instances and/or other types of executable code. Note, the use of the term “application instance” when used in the context of cloud computing refers to an instance within the cloud infrastructure for executing applications (e.g., for a customer in that customer's isolated instance).

As noted, cloud-based provisioning of network devices is a popular methodology employed in computer networks, particularly in software-defined wide-area networks (SDWANs). The term wide-area network (WAN) refers to the functional interconnection, i.e., network, of computers or computing resources across physically distant locations, as opposed to a local-area network (LAN), which is usually a network of computers or computing resources which are in closer physical proximity to one another. As noted, an SDWAN may be implemented to establish a computing infrastructure between a central office and one or more branch offices of an enterprise.

A WAN may be used, for example, to connect the computing resources, including LANs, of one or more branch offices of an enterprise to a central enterprise network, such as a central LAN, or to connect data centers separated by a distance.

The term “cloud,” as in “cloud computing” or “cloud resource,” refers to a paradigm that enables ubiquitous access to shared pools of configurable computational resources and higher-level services that, can be rapidly provisioned with minimal management effort; often, cloud resources are accessed via the Internet. An advantage of cloud computing and cloud resources is that a group of networked computing resources providing services need not be individually addressed or managed by users; instead, an entire provider-managed suite of hardware and software can be thought of as an amorphous “cloud.”

The term “provisioning,” as in the provisioning of network(ed) devices and computational resources, refers to the process of preparing and equipping a network to allow it to operatively couple devices to a network and provide new services to its users.

As noted, SDWANs may include at least one Branch Office Controller (BoC) in network communication with at least one master controller (MC). As its name suggests, a BoC may be associated with and located at a branch office of an enterprise. A branch office controller may also variously and interchangeably be referred to as a branch office router or gateway among other possible descriptors. An MC may be associated with and maintained at a central location of the enterprise. A master controller may be also variously and interchangeably referred to as a gateway or central gateway, a datacenter router, or a master gateway, among other possible descriptors. A first provisioning redirector resource, alternatively referred to as a “provisioning server” may function to establish communication between an MC and a BoC. A network platform computing resource, such as a cloud platform server, may provide a configuration template including network device details specified for the BoC to the MC, which in turn pushes this configuration information to the BoC.

A potential shortcoming of SDWAN methodologies described above is that the real-time physical connection and other configuration variables of network devices at a branch office, including BoCs and devices associated with and operatively coupled to BoCs, can for various reasons deviate from configuration template and device address information specified for the branch office and maintained by the cloud platform server, leading to a logical breakdown in communication between the branch office and the central office.

An approach to avoid such a problem involves collecting real-time network physical connection and connected device information for devices at a branch office and passing this information to the cloud platform server. By “real-time network physical connection and connected device information,” it is meant information that reflects such information as the type, vendor, and model information about network devices connected to the BoC or network switch being provisioned, including how they are operably connected in a network, as opposed to device information that is specified in a configuration template or otherwise only expected or intended to be accurate. This enables the cloud platform server to adjust the configuration template information to reflect real-time network physical connection and connected device information before promulgating this configuration information to the MC, to BoCs, or to other network devices such as switches, routers, access points, and so on.

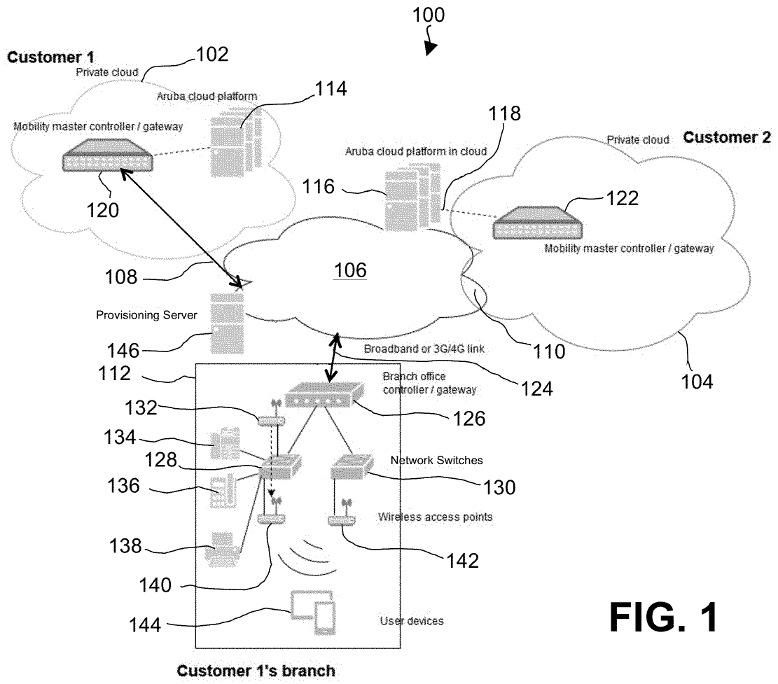

Referring to FIG. 1, there is shown an example of a software-defined wide-area network (SDWAN) infrastructure 100. SDWAN infrastructure 100 of FIG. 1 includes two private clouds 102 and 104 separately maintained by and associated with two customers, Customer 1 and Customer 2, although it will be understood that a particular SDWAN, infrastructure may be established in support of more or fewer customers.

Each private cloud 102 and 104 is in network communication with the Internet 106. In the case of Customer 1 private cloud 102, there is shown a connection 108 to the Internet 106, and for Customer 2 private cloud 104, the connection with the Internet 106 is reflected by overlapping area 110 of Customer 2 private cloud 104 and the Internet 106.

Also shown in FIG. 1 is a Customer 1 branch 112. Customer 1 branch 112. In this example, branch 112 may represent a branch office of Customer 1 that is located physically (e.g., geographically) distant from a headquarters of Customer 1 from which private cloud 102 is maintained.

Each private cloud 102, 104 has an associated network platform computing resource. In this example, the network platform computer resource comprises a cloud platform (e.g., a cloud server) including the computational resources (hardware and software) which facilitate implementation of the respective SDWANs. A current commercial example of a cloud platform is embodied in the products and services offered by Aruba, a Hewlett Packard Enterprise Company, Palo Alto, Calif. (www.arubanetworks.com).

For Customer 1 private cloud 102, a cloud platform 114 is maintained by Customer 1 within private cloud 102. For Customer 2 private cloud 104, a cloud platform 116 is maintained in a cloud, i.e., not necessarily or entirely within Customer 2 private cloud 104, but being accessible to Customer 2 private cloud 104 either via a direct link, as represented by connection 118 in FIG. 1, or via the Internet 106, to which both Customer 2 private cloud 104 and cloud platform 116 are connected, as depicted in FIG. 1.

Customer 1 private cloud 102 and Customer 2 private cloud 104 each include a master controller (MC). In FIG. 1, the MC for Customer 1 is designated with reference numeral 120; the MC for Customer 2 is designated with reference numeral 122. Operation of MCs in the present example will hereinafter be described in further detail.

With continued reference to FIG. 1, Customer 1 branch 112 is coupled to the Internet 106 via a link 124, which may be, for example, a broadband or 3G/4G link.

At branch 112, the connection 124 to the Internet 106 may be established through a branch office controller (BoC) 126, whose operation will be hereinafter described in further detail. BoC 126, in turn, serves as a gateway to other associated network devices at the branch 112, including in the example of FIG. 1, multi-port network (e.g., Ethernet) switches 128 and 130. BoC 126 may also have an associated wireless access points (WAPs) 132, 140, and 142 for wireless (e.g., WiFi) communication with other network devices at branch 112. Although two network switches 128 and 130 and three WAPs 132, 140, and 142 are depicted in FIG. 1, it will be understood that more or fewer numbers of such devices may be associated with a branch controller in a given system.

As is customary, each switch 128 and 130, as one type of network device, functions to couple at least one—and often more than one—other network device to BoC 126. In FIG. 1, Network switch 128 is illustratively shown being coupled to multiple network devices such as a networked photocopier 134, a networked computer 136, a networked printer 138, and wireless access points (WAPs) 132 and 140. Switch 130 is shown coupled to a wireless access point (WAR) 142. Wireless access points 132, 140 and 142 can each facilitate network communication with a plurality of additional, wireless user devices (e.g., mobile phones, tablets), collectively represented with reference numeral 144 in FIG. 1.

It is to be noted that all of the devices associated with branch 112, including BoC 126, switches 128 and 130, WAPs 132, 140, 142, and so on, each have their own configuration information. An individual device's configuration information includes such items as its network (e.g., IP) address, the identification of specific communications ports to which it connects to other devices, driver and communication protocol information, and so on.

As will be understood, each switch 128, 130 may serve to associate a plurality (e.g., 16, 48, 96 or more) of other individual network devices with BoC 126, allowing network communication with the associated network devices over the SDWAN infrastructure 100. Many different types of network devices, in addition to the photocopier 134, computer 136, printer 138, and WAPs 132, 140 and 142 shown in FIG. 1 may be associated with a BoC by being connected to a switch, including, by way of example and not limitation, digital menus, Internet-of-Things (IoT) devices, and so on. As will be appreciated, each device may have its own network configurations, connection requirements and connection port assignments, policy constraints, and so on.

A further component of the SDWAN infrastructure 100 of FIG. 1 is a provisioning redirector resource, such as provisioning server 146, connected to the Internet 106 as shown and functioning to coordinate SDWAN operation, as will be hereinafter described.

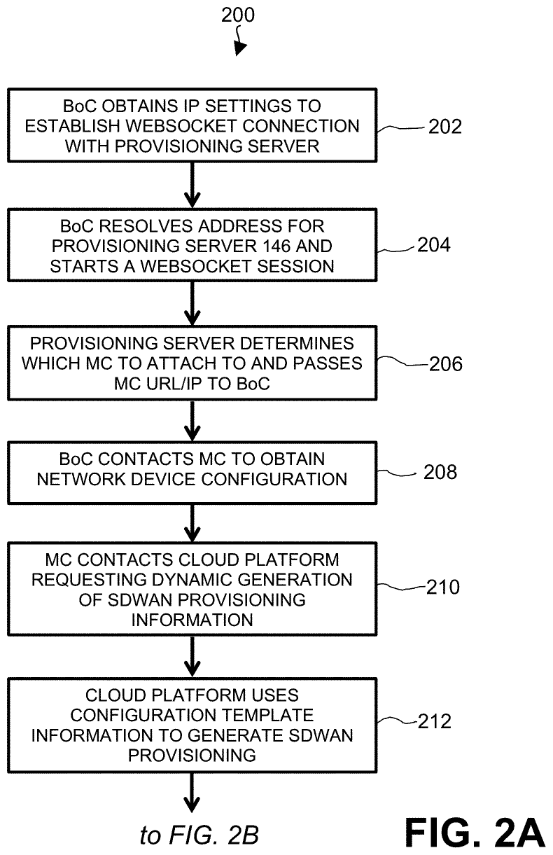

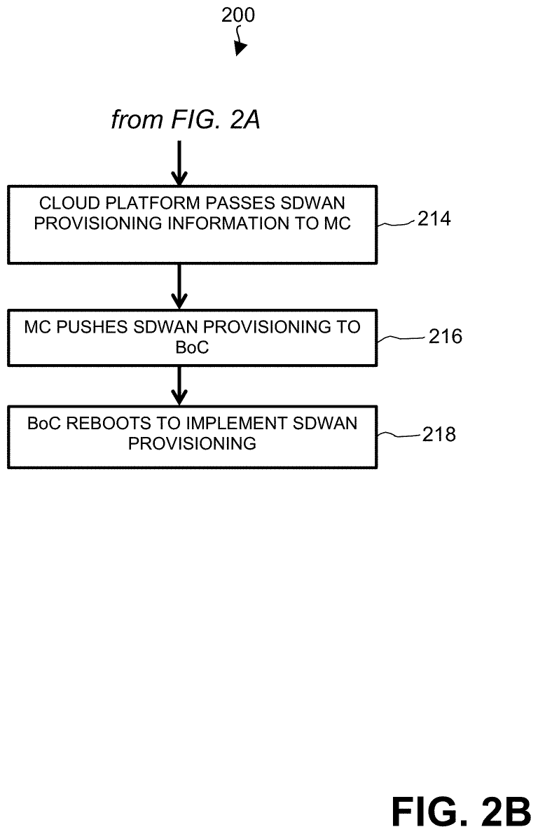

FIGS. 2A and 2B together comprise a single flow diagram 200 depicting an operational methodology of an SDWAN infrastructure such as infrastructure 100. First, as represented by block 202 in FIG. 2A, BoC 126 obtains Internet Protocol (IP) settings to establish a websocket connection with provisioning server 146. As is known, a websocket is a computer communications protocol providing full-duplex communication channels over a transmission control protocol (TOP) connection and is the primary interface for connecting to a server and then sending and receiving data on the connection. Such IP websocket settings may be obtained, for example, from a broadband router (not shown) providing broadband link 124 between branch 112 and the Internet 106.

Having obtained the IP settings, BoC 126 establishes a websocket session with provisioning server 146, as represented by block 204 in FIG. 2A. The identity of BoC 126 is provided to provisioning server 146 in a unique identifier in the form of, e.g., a serial number and/or media access control (MAC) address, for BoC 126. The MAC address is a unique identify assigned to a network device for communication at the data link layer of a network connection.

Based on the serial number and/or MAC address of BoC 126, in block 206 of FIG. 2A, provisioning server 146 determines which master controller (MC) is to be associated with BoC 126, and transmits the uniform resource locator (URL) and/or IP address of the appropriate MC to BoC 126. In this example, MC 120 is associated with branch 112. BoC 126, in turn, contacts MC 120 to request and obtain configuration information concerning the network devices associated with branch 112, as represented by block 208 in FIG. 2A.

In block 210 of FIG. 2A, MC 120 contacts cloud platform 114 to request generation of SDWAN provisioning information for BoC 126. Cloud platform 114 maintains a configuration template for customer branches (such as branch 112) in a database. The configuration template can be a generic or standard configuration, such as for multiple branches of an enterprise. The configuration template may include such information as the number of branches and BoCs, the respective IP s subnetworks associated with those branches, the allocation of IP addresses to devices in those branches, and so on. On the other hand, certain configuration variables such as IP addresses, hostnames, and so on, may not be specified in the configuration template for the branch but may be supplied at a later time, such as during network deployment. Thus, cloud platform 114 generates the SDWAN provisioning information for BoC 126 using configuration template information, as represented by block 212 in FIG. 2A.

Turning to FIG. 2B, following block 212 from FIG. 2A, in block 214 cloud platform 114 transmits the SDWAN BoC provisioning information for BoC 126 to MC 120. Next, in block 216, MC 120 pushes the SDWAN provisioning information to BoC 126. Using this information, in block 218, BoC 126 reboots to implement its provisioning as specified by cloud platform 114.

After BoC 126 is provisioned as described with reference to FIGS. 2A and 2B, downstream branch network devices such as switches 128 and 130 may be provisioned subsequently by cloud platform 114.

In SDWAN infrastructures operated as described with reference to FIGS. 2A and 2B, it is possible for real-time network physical connection and connected device information of network devices in a branch, such as branch 112, to deviate from network device configuration reflected in the configuration template and predetermined information maintained by a cloud platform, such as cloud platform 114. This discrepancy between real-time network physical connection and connected device information versus template or otherwise predetermined information stored by a cloud platform can arise for any number of reasons. For example, consider that an network switch, such as network switches 128 and 130 in FIG. 1, can have many ports, e.g., 48 or 96 ports. Configurations generated by a cloud platform such as cloud platform 114 may assume that each and every network device associated with a branch, such as branch 112, are properly connected to the ports of the network switch, i.e., that particular network devices with unique individual device configuration information variables are connected, and that these network devices are connected to the switch in a particular order. However, in practical settings, such connections are susceptible to intentional or inadvertent changes. Where such discrepancies exist, the SDWAN provisioning information generated by cloud platform 114 and pushed from the MC 120 to the BoC 126 will not be valid; that is, the provisioning of the network devices, including configurations for virtual local area network (VLAN) membership, access control lists (ACLs), policies, and the like, will be incorrect, undesirably leading to non-functional connections and the need for manual intervention for resolution of the problem(s).

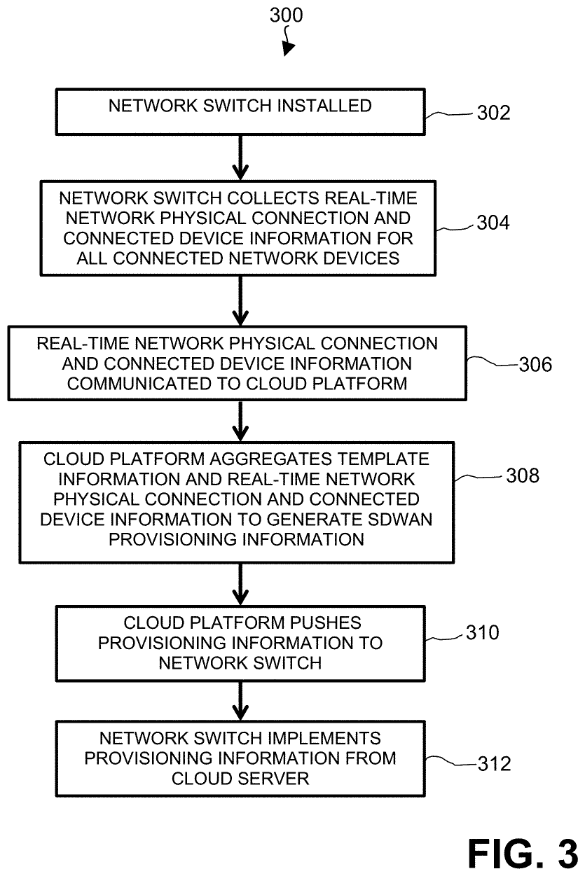

Turning now to FIG. 3, there is shown a flow diagram 300 illustrating an example method of an SDWAN infrastructure. As in FIGS. 2A and 2B, the methodology depicted in FIG. 3 relates to the SDWAN infrastructure 100 of FIG. 1 and begins upon the operational installation of a device in the branch network 112, such as network switch 128, as represented by block 302. In this example, at block 304, switch 128 accumulates, determines or is otherwise provided with real-time network physical connection and connected device information (e.g., device physical port number, connected device type, device vendor, device model, etc.) for all its connected network devices. Information about connected devices can be collected using protocols such as Link Layer Discovery Protocol (LLDP) and techniques like MAC address and organizationally unique identifier (OUI) lookup. As is known, the LLDP is a vendor-neutral link layer protocol on the Internet Protocol Suite used by network devices for advertising their identity, capabilities, and neighbors on local area networks such as wired Ethernet networks. OUIs are unique device identifiers assigned by the IEEE Registration Authority to identify companies, organizations, entities, manufacturers, vendors, and so on.

In block 306 of the method 300), real-time network physical connection information and connected device information is communicated to cloud server to cloud platform 114. Such communication may occur, for example, by being relayed through BoC 126 and/or provisioning server 146, or may occur more directly, depending on the implementation.

In block 308 of the method 300, cloud platform 114 aggregates SDWAN template information and the real-time network physical connection and connected device information to generate updated SDWAN provisioning information.

In block 310, the updated SDWAN provisioning information is pushed back to network switch 128, and in block 312, Network switch 128 implements the updated SDWAN provisioning information.

The method described with reference to FIG. 3 affords certain benefits, inasmuch as it enables the device provisioning in an SDWAN to reflect real-time network physical connection and connected device information, rather than only pre-specified configurations such as may be provided in templates, which may differ from actual, real-time ones.

Thus, for example, if a branch office network administrator responsible for wiring and connecting network devices at a branch location either intentionally or unintentionally deviates from the configuration details pre-specified by or to cloud platform 114, such as by connecting devices to a port of a network switch other than the ones specified in advance and thus reflected in the predetermined data maintained in cloud platform 114, this discrepancy can be resolved through the providing of real-time network physical connection and connected device information to the cloud platform.

Another advantage afforded by a methodology such as the example of FIG. 3 is that it enables a network administrator, such as a branch office network administrator to purposefully initiate a reboot of BoC 126 or any other network device in order for current real-time network physical connection and connected device information to be incorporated into the SDWAN device provisioning information derived by cloud platform 114. Thus, for example, if a network administrator purposefully changes the real-time network physical connection and/or connected network devices, a network administrator can preferably issue a provisioning request to initiate the methodology described in FIG. 3 to cause SDWAN device provisioning to be updated to reflect changes that are made, either to the predetermined network device information or to the real-time network physical connection and connected device information, e.g., to perform a provisioning update. Alternatively, or additionally, a network administrator can preferably issue a provisioning request to initiate the methodologies described herein to cause SDWAN device provisioning to be reset to a previously saved or otherwise predetermined state, i.e., to perform a provisioning reset. In either case, the resulting network provisioning can reflect changes to both predetermined network device information and real-time network physical connection and connected device information.

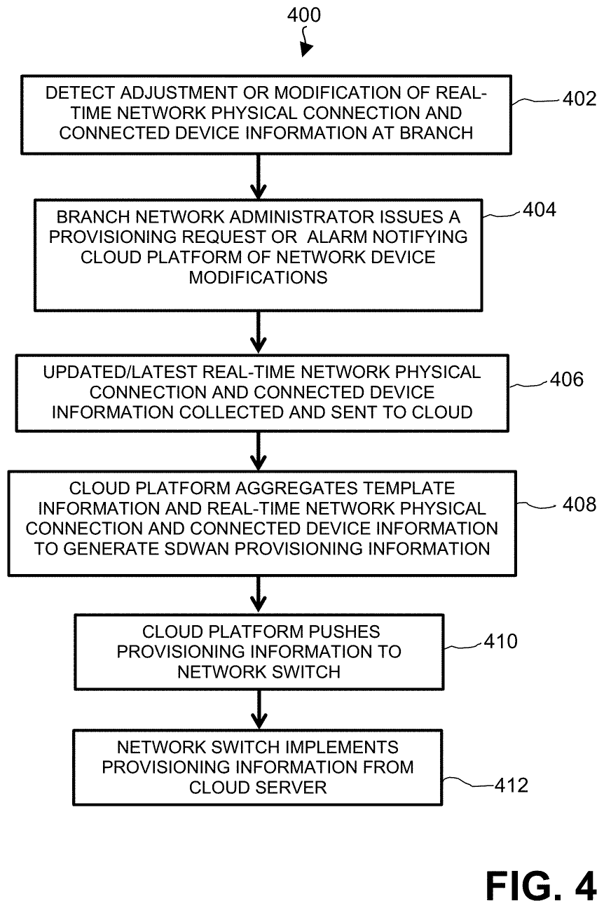

FIG. 4 is a flow diagram 400 illustrating an example method for SDWAN 100. In this example, in block 402, an adjustment or modification to the real-time network physical connections and/or connected devices at branch 112 is detected. Such adjustments or modifications may be detected by BoC 126 or by a network switch 128, 130, for example. Such adjustments or modifications may include, for example, adding new network devices, swapping a defective network device with a replacement, modifying the order in which network devices are connected to one of network switches 128, 130, and so on. As will be appreciated, such modifications may be made without previously updating the template and device predetermined device information maintained by cloud platform 114.

Having made device adjustments or modifications, the network administrator at branch 112 can, in accordance with the methodology set forth with reference to FIG. 3, update the SDWAN device provisioning information in order to ensure proper network operation. The branch network administrator can accomplish this by sending a provisioning request or alarm to MC 120, as represented by block 404 in FIG. 4, notifying MC 120 that modifications to device configuration have occurred.

Prior to, concurrently with, or subsequent to sending a provisioning request or alarm (as at block 404), the updated or latest real-time network physical connection and connected device information regarding connected network devices can be collected and sent to cloud platform 114, as shown in block 406.

In block 408, cloud platform 114 generates new SDWAN device provisioning information by aggregating the updated real-time network physical connection and connected device information with any stored predetermined device information and templates.

In block 410, the new SDWAN device provisioning information is pushed back to network switch 128, and in block 412, Network switch 128 implements the new SDWAN device provisioning information, such as by resetting, rebooting, or otherwise.

An advantage afforded by a methodology such as the examples of FIGS. 3 and 4 is that by providing the real-time network physical connection and connected device information to cloud platform 114, cloud platform 114 can be configured perform a comparison between such real-time network physical connection and connected device information and the other pre-specified configuration information and configuration templates stored at cloud platform 114.

Thus, for example, predetermined device and variable device information stored on cloud platform 114 can be aggregated with real-time network physical connection and connected device information so that SDWAN provisioning may reflect and identify the hardware (e.g., network device MAC addresses, serial numbers, and the like) that has been allocated to a branch such as branch 112. When cloud platform 114 undertakes to aggregate the SDWAN device provisioning information (step 308 in FIG. 3, step 408 in FIG. 4), cloud platform 114 can reconcile the real-time network physical connection and connected device information it has been supplied with pre-specified configuration information and configuration templates.

Another advantage is that in connection with the aggregation function performed by cloud platform 114 (e.g., block 308 in FIG. 3 or block 408 in FIG. 4), cloud platform 114 may be provided with authorization information which indicates which devices (either specific devices, or categories of devices) are authorized or not authorized to be included in a particular SDWAN (i.e., “whitelisted” or “blacklisted”), and thus incorporated into the provisioning information generated by clout platform 114. This can ensure that cloud platform 114 properly incorporates certain devices into, or excludes certain devices from, the SDWAN device provisioning information it provides.

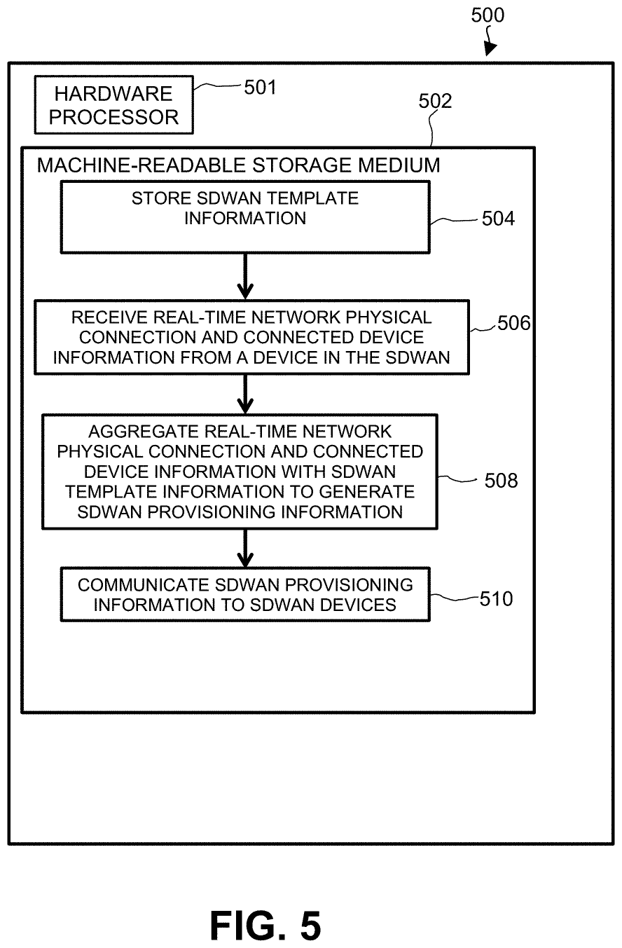

FIG. 5 is a block diagram representing a network platform computing resource 500 implementing a method of infrastructure program management, according to one or more disclosed examples. Computing resource 500 includes at least one hardware processor 501 and a machine readable storage medium 502. As illustrated, machine readable medium 502 may store instructions, that when executed by hardware processor 501 (either directly or via emulation/virtualization), cause hardware processor 501 to perform one or more disclosed methods associated with SDWAN provisioning.

In the example of FIG. 5., the machine-readable storage medium 502 tangibly embodies instructions for causing computing resource 500 to function as a cloud platform such as platform 114 in FIG. 1, namely, to perform the following:

In block 504, the instructions enable and cause computing resource 500 to store SDWAN template information.

In block 506, the instructions enable and cause computing resource 500 to receive real-time network physical connection and connected device information from a device in an SDWAN. Such information may come from a BoC, a networking switch, gateway, router or other network device.

In block 508, the instructions enable and cause computing resource 500 to aggregate the real-time SDWAN physical connection and connected device information with SDWAN template information to generate SDWAN provisioning information.

In block 510, the instructions enable and cause computing resource 500 to communicate the SDWAN provisioning information generated in block 508 to one or more devices in the SDWAN, for example, a BoC, gateway, switch, router, or other device in the SDWAN.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to.” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A method of provisioning network devices in a network, comprising:
determining, at a branch office controller, real-time network physical connection and connected device information for at least one network device associated with said branch office controller;
communicating said real-time network physical connection and connected device information to a network platform computing resource;
generating network provisioning information by aggregating configuration template information with said real-time network physical connection and connected device information; and
communicating said network provisioning information from said network platform computing resource to said branch office controller.

2. The method of claim 1, wherein said at least one network device comprises a multi-port network switch.

3. The method of claim 1, wherein said branch office controller establishes a connection to a master controller coupled to said network platform computing resource.

4. The method of claim 3, wherein said branch office controller establishes said connection to said master controller by obtaining a master controller address from a provisioning redirector resource.

5. The method of claim 1, wherein said generating of network provisioning information is performed in response to a provisioning request issued by a network administrator.

6. The method of claim 1, further comprising:
identifying, in said configuration template information, network devices authorized to be included in and network devices to be excluded from, said network provisioning information.

7. The method of claim 1, wherein said at least one network device contacts a provisioning redirector in order to establish communication with said network platform computing resource.

8. A non-transitory computer-readable medium tangibly embodying instructions executable by a hardware processor to:
store predetermined network device information for devices in a computer network in a network platform computing resource;
communicate real-time network physical connection and connected device information from a branch controller to said network platform computing resource;
generate network provisioning information based on said predetermined network device information and said real-time network physical connection and connected device information; and
provide said network provisioning information to said branch controller.

9. The non-transitory computer-readable medium of claim 8, wherein said real-time network physical connection and connected device information reflects a configuration of at least one network device coupled to said branch controller.

10. The non-transitory computer-readable medium of claim 9, wherein said at least one network device comprises a network switch.

11. The non-transitory computer-readable medium of claim 8, wherein said generation of network provisioning information is performed in response to a provisioning request issued by a network administrator.

12. The non-transitory computer-readable medium of claim 8, further comprising:
identifying, in said predetermined network device information, network devices authorized to be provisioned in said computer network.

13. The non-transitory computer-readable medium of claim 12, wherein said predetermined network device information includes information identifying network devices authorized to be included in and network devices to be excluded from, said network provisioning information.

14. The non-transitory computer-readable medium of claim 8, further comprising:
providing a provisioning redirector resource for establishing communication between said network platform computing resource and said branch controller.

15. A computer network comprising:
a branch office controller in communication with a network platform computing resource which maintains predetermined network device configuration information, said branch office controller being configured to provide real-time network physical connection and connected device information to network platform computing resource; and
a plurality of network devices associated with said branch office controller,
wherein said network platform computing resource generates network device provisioning information for said plurality of network devices based on said real-time network physical connection and connected device information and said predetermined network device configuration information, and provides said network device provisioning information to said branch office controller.

16. The computer network of claim 15, wherein said network platform computing resource comprises a cloud server.

17. The computer network of claim 15, wherein said plurality of network devices includes a network switch.

18. The computer network of claim 15, further comprising a provisioning server for establishing communication between said master controller and said branch controller.

19. The computer network of claim 15, wherein said master controller is responsive to a network administrator request to generate said network device provisioning information.

20. The computer network of claim 15, wherein said predetermined network device configuration information includes identification of at least one network device that is authorized to be provisioned in said computer network.
